(19) United States
(12) Patent Application Publication
(10) Pub. No.: US 2018/0059725 A1
(43) Pub. Date: Mar. 1, 2018

(54) TABLET PROTECTIVE COVER AND ELECTRONIC DEVICE

(71) Applicant: PEGATRON CORPORATION, Taipei City (TW)

(72) Inventors: Hung-Yun WU, Taipei City (TW); Shyh-Heh HWANG, Taipei City (TW); Ho-Ching HUANG, Taipei City (TW); Hui-Chen WANG, Taipei City (TW); I-Tien HSIEH, Taipei City (TW)

(21) Appl. No.: 15/643,286

(22) Filed: Jul. 6, 2017

(30) Foreign Application Priority Data
Aug. 26, 2016 (TW) 105127570

(51) Int. Cl. G06F 1/16

(52) U.S. Cl. CPC G06F 1/1632

(57) ABSTRACT

A tablet protective cover and electronic device using the same is applied for connecting the tablet to a dock for expanding the tablet. The tablet protective cover includes a bearing seat, a back cover and a hook. The bearing seat is located on a hinge of the dock. A first end of the back cover is connected to the bearing seat, so that the back cover can rotate relative to the dock. The tablet can be placed on the bearing seat and electrically connected to the dock, and the back cover covers the back of the tablet. The hook is located on a second end of the back cover away from the bearing seat for fixing the tablet on the bearing seat, and when the back cover and the dock angle is zero, the hook and the snap unit of the dock could engage each other.

### CROSS REFERENCE TO RELATED APPLICATIONS

This Non-provisional application claims priority under 35 U.S.C. § 119(a) on Patent Application No. 105127570 filed in Taiwan, Republic of China on Aug. 26, 2016, the entire contents of which are hereby incorporated by reference.

### BACKGROUND

### Technology Field

The present disclosure relates to a tablet protective cover and, in particular, to a tablet protective cover capable of fixing the table by a hook disposed on the back cover.

### Description of Related Art

The conventional dock generally provides a bearing seat for receiving the tablet, so the weight of the tablet is concentrated in the hook inside the bearing seat. When the size of the tablet is too large, the above mechanism for fixing the bottom of the tablet only may not strong enough. The bearing seat further includes a release member for moving the hook to release the tablet. In addition, it may be unstable to maintain the closed state of the tablet and the dock by the torque of the hinge itself in the dock.

Therefore, it is desired to provide a tablet protective cover having a hook disposed on the back cover.

### SUMMARY

The present disclosure provides a tablet protective cover and an electronic device that can solve the problems of unfirmly installation and stress concentration, which are caused by the connection mechanism of the conventional tablet and dock.

In order to achieve the above, the present disclosure discloses a tablet protective cover for connecting a tablet to a dock for expanding the tablet. The tablet protective cover includes a bearing seat, a back cover, and a hook. The bearing seat is located on a hinge of the dock. A first end of the back cover is connected to the bearing seat, so that the back cover is capable of rotating relative to the dock. The tablet is placed on the bearing seat and electrically connected to the dock, and the back cover covers the back of the tablet. The hook is located on a second end of the back cover away from the bearing seat for fixing the tablet on the bearing seat. When the back cover and the dock angle is zero, the hook and the snap unit of the dock are able to engage each other.

In one embodiment, the hook is rotated for fixing the tablet.

In one embodiment, the back cover is made of metal or plastic material.

In addition, the disclosure also discloses an electronic device for connecting to a tablet. The electronic device includes a dock and a tablet protective cover. The tablet protective cover includes a bearing seat, a back cover and a hook. The bearing seat is located on a hinge of the dock. A first end of the back cover is connected to the bearing seat, so that the back cover is capable of rotating relative to the dock. The tablet is placed on the bearing seat and electrically connected to the dock, and the back cover covers the back of the tablet. The hook is located on a second end of the back cover away from the bearing seat for fixing the tablet on the bearing seat. When the back cover and the dock angle is zero, the hook and the snap unit of the dock are able to engage each other.

In one embodiment, the hook is rotated for fixing the tablet.

In one embodiment, the back cover is made of metal or plastic material.

In one embodiment, the dock has a storage slot that disposed a snap unit and engages the hook each other.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing a tablet protective cover according to an embodiment of the disclosure;

FIG. 2 is a schematic diagram showing the tablet protective cover in operation according to an embodiment of the disclosure;

FIG. 3 is a schematic diagram showing the angle between the back cover and the dock is zero to an embodiment of the disclosure;

FIG. 4 is a schematic diagram showing that the hook and the snap unit of the dock engage each other an embodiment of the disclosure.

### DETAILED DESCRIPTION OF THE DISCLOSURE

The present disclosure will be apparent from the following detailed description, which proceeds with reference to the accompanying drawings, wherein the same references relate to the same elements.

In the following descriptions, the terms, such as “comprise”, “include”, “have”, “contain” and the likes, are limiting words and should be understood as “include and not limit to”.

In the following descriptions, the term “and/or” should be any or all combinations of the listed objects.

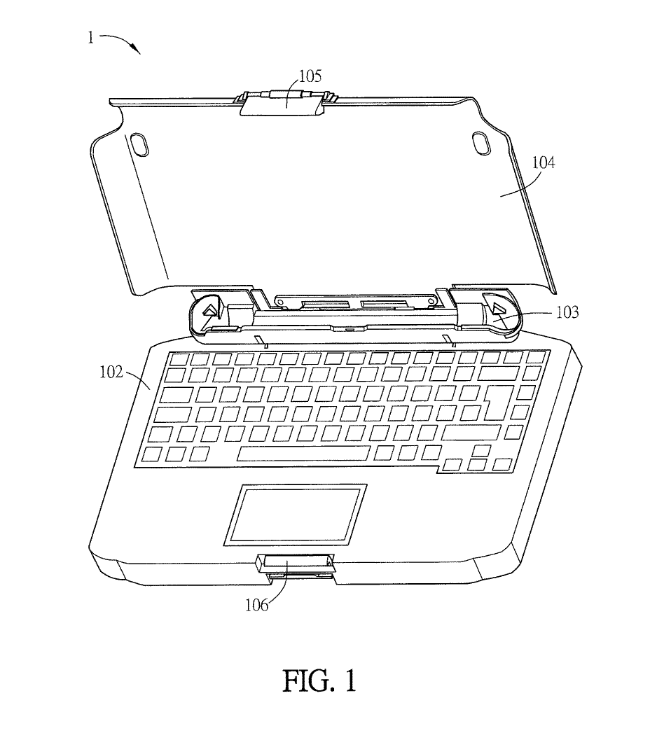

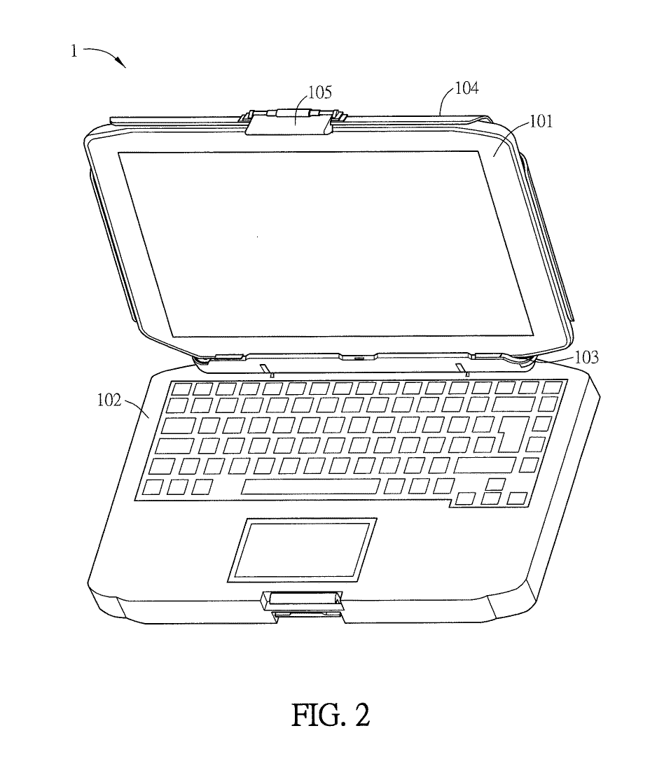

FIG. 1 is a schematic diagram showing a tablet protective cover 1 according to an embodiment of the disclosure, and FIG. 2 is a schematic diagram showing the tablet protective cover 1 in operation according to an embodiment of the disclosure. In this embodiment, as shown in FIGS. 1 and 2, the tablet protective cover 1 is applied to connecting a tablet to a dock 102 for expanding the tablet. The tablet protective cover 1 includes a bearing seat 103, a back cover 104, and a hook 105. The bearing seat 103 is located on a hinge of the dock 102. A first end of the back cover 104 is connected to the bearing seat 103, so that the back cover 104 can be rotated relative to the dock 102.

In practice, the tablet is placed on the bearing seat 103 and electrically connected to the dock 102, and the back cover 104 covers the back of the tablet. The hook 105 is located on a second end of the back cover 104 away from the bearing seat 103 for fixing the tablet 101 on the bearing seat 102.

In this embodiment, the hook 105 is rotated for fixing the tablet 101.

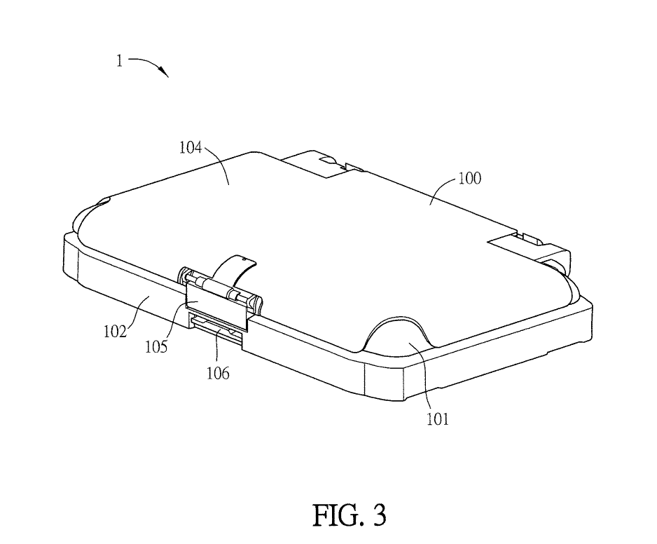

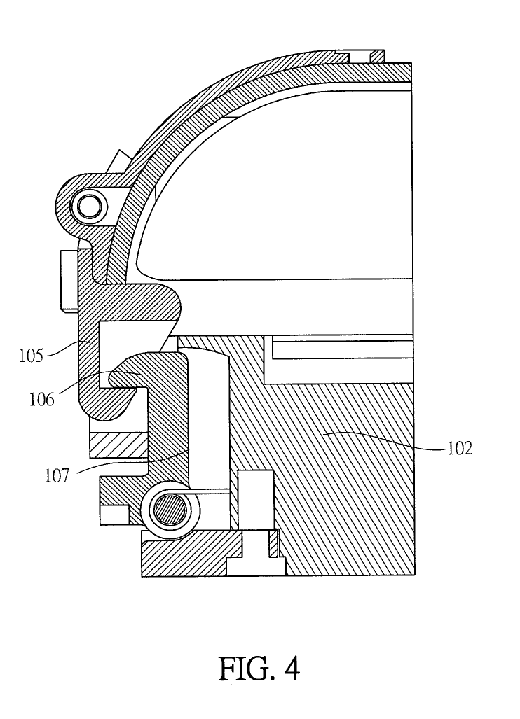

FIG. 3 is a schematic diagram showing the angle between the back cover 104 and the dock 102 is zero to an embodiment of the disclosure, and FIG. 4 is a schematic diagram showing that the hook 105 and a snap unit 106 of the dock engage each other an embodiment of the disclosure. In this embodiment, as shown in FIGS. 3 and 4, when the tablet 101 and the dock 102 keep in the maintenance of closed state, which the back cover 104 and the dock 102 angle is zero, the hook 105 and the snap unit 106 of the dock 102 could engage each other.

In this embodiment, the dock 102 has a storage slot 107 that the snap unit 106 is disposed in the storage slot 107.

In addition, the above-mentioned tablet protective cover can be applied to an electronic device for connecting to a tablet. The electronic device includes a dock for expanding the tablet and a tablet protective cover. The tablet protective cover includes a bearing seat, a back cover and a hook. Since the hook disposed on the back cover can assist to firmly fix the tablet, the tablet protective cover of the disclosure can solve the problems of unfirmly installation and focusing force at the hook inside the bearing seat, which are caused by the connection mechanism of the conventional tablet and dock with the hook inside the bearing seat only. In addition, the hook and the snap unit of the dock could engage each other, which can solve the tablet and the dock in the maintenance of closed state only rely the torque of the hinge itself in the dock may cause stability is not enough.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A tablet protective cover for connecting a tablet to a dock for expanding functions of the tablet, the tablet protective cover comprising:
a bearing seat located on a hinge of the dock;
a back cover, wherein a first end of the back cover is connected to the bearing seat, so that the back cover is capable of rotating relative to the dock, the tablet is placed on the bearing seat and electrically connected to the dock, and the back cover covers a back of the tablet; and
a hook located on a second end of the back cover away from the bearing seat for fixing the tablet on the bearing seat, and when the back cover and the dock angle is zero, the hook and the snap unit of the dock are able to engage each other.

2. The tablet protective cover of claim 1, wherein the hook is rotated for fixing the tablet.

3. The tablet protective cover of claim 1, wherein the back cover is made of metal or plastic material.

4. An electronic device for connecting to a tablet, comprising:
a dock for expanding the tablet;
a bearing seat located on a hinge of the dock;
a back cover, wherein a first end of the back cover is connected to the bearing seat, so that the back cover is capable of rotating relative to the dock, the tablet is placed on the bearing seat and electrically connected to the dock, and the back cover covers a back of the tablet; and
a hook located on a second end of the back cover away from the bearing seat for fixing the tablet on the bearing seat, and when the back cover and the dock angle is zero, the hook and the snap unit of the dock are able to engage each other.

5. The electronic device of claim 4, wherein the hook is rotated for fixing the tablet.

6. The electronic device of claim 4, wherein the back cover is made of metal or plastic material.

7. The electronic device of claim 4, wherein the dock has a storage slot that the snap unit is disposed in the storage slot.
